(19) United States
(12) Patent Application Publication
(10) Pub. No.: US 2008/0245217 A1
(43) Pub. Date: Oct. 9, 2008

(54) Nearly Closed Magnetic Flux Electromagnetic Transducer for Instrument Pickups

(76) Inventor: Bret Thomas Stewart, Seattle, WA (US)

Correspondence Address: Bret Stewart, 1153 Appleland Drive, Wenatchee, WA, 98801, US

(21) Appl. No.: 11/697,718

(22) Filed: Apr. 7, 2007

(51) Int. Cl. G10H 3/18

(52) U.S. Cl. 84/727; 84/726

(57) ABSTRACT

An improved electromagnetic transducer for use in electric instrument pickups is described. The magnetic circuit of the transducer is almost entirely enclosed, leading to a very efficient and quiet design. A magnetically susceptible transducer core (1) is shaped in such a way that it provides a closed path for magnetic flux everywhere except a gap (3) through which one or more ferromagnetic strings (4) pass. One or more electrically conductive coils (2) disposed on core (1) convert the magnetic flux passing through the core into electric current. A lengthwise magnetic field is applied to the string using a specially shaped magnetic element, consisting of either a permanent magnet (5) or magnetically susceptible magnetizing core (6) about which one or more coils (7) are disposed. In either case, the magnet element is shaped in such a way as to contain magnetic flux within itself everywhere except a section wherein the magnetic flux is driven longitudinally through one or more magnetically susceptible strings.

### FIELD OF INVENTION

This invention relates to electromagnetic transducers, devices that convert the mechanical vibrations of a magnetically permeable object, such as a ferromagnetic instrument string, into an electrical signal using electromagnetism.

### DISCUSSION OF PRIOR ART

Electromagnetic transducers have been used in musical instruments for many years. When used on instruments, a transducer is commonly referred to as a pickup. The most common type of pickup, as seen on most modern electric guitars, consists of a single group of windings around several cylindrically shaped magnetic elements (pole pieces), as described in U.S. Pat. No. 2,968,204 to Fender (1961). This type of pickup is plagued with several problems. First, the linear design of the pickup often causes it to reproduce stray electromagnetic fields, introducing unwanted noise when the sound is reproduced in an amplifier. U.S. Pat. No. 4,378,722 to Isakson (1981) attempted to fix this problem by introducing pickups that are ring-shaped. While the ring-shaped pickup is the correct geometry for preventing stray magnetic flux from entering the systems, this design ran strings through the center of a completely closed coil, which is not an efficient design: the string only weakly affects the magnetic field in the coil and thus drives little current in the coil. U.S. Pat. No. 3,571,483 to Davidson (1971) recognized the advantages of using nearly closed magnetic flux in an instrument pickup; however, this design is quite complicated and does not lend itself to interfacing with standard guitars and guitar amplifiers currently in use. Both of the previous systems amplify the string vibrations in all planes, resulting in harmonic content undesirable for both analog and digital systems.

Secondly, conventional pickup design necessitates the use of powerful permanent or electromagnets since most of the magnetic flux is wasted on the space surrounding the strings. As materials science has progressed, increasingly powerful (and expensive) permanent magnets and electromagnets have been employed in guitar pickups, increasing their manufacturing cost and complexity.

Third, conventional pickups inherently cannot separate the signal of each individual string from the other strings. This means that pickup design is traditionally a compromise between the ability to reproduce the high and low frequencies that make up the entire range of the electric instrument. This trait also makes the conventional pickup impractical for use with instruments that have many strings, such as a piano, since a pickup of this type can only be built so large before its very high impedance destroys its response to high frequencies in the audio that will be reproduced.

When interfacing electronic string instruments with digital equipment, it is advantageous to reproduce each string individually and in a single plane of vibration, as this makes digitization simpler because the signal is purer. Several pickup designs that reproduce each string individually and/or in one geometric plane do exist, such as U.S. Pat. No. 6,392,137 to Isvan (2002), U.S. Pat. No. 7,166,794 to Juszkiewicz (2003), U.S. Pat. No. 3,571,483 to Davidson (1971), and U.S. Pat. No. 4,378,722 to Isakson (1981). The first two previous solutions have still relied on traditional, wasteful cylindrical coil configurations. Davidson's design, as previously discussed, is needlessly complicated and reproduces undesirable harmonic content. Isakson's solution, as discussed earlier in this section, is inefficient due to its coil design. Until now, no single pickup design has eliminated all of these technical issues.

### OBJECTS AND ADVANTAGES

This proposed pickup design represents a vast improvement over previous pickup designs. Because the magnetic flux in this pickup is virtually self-contained (nearly closed magnetic flux) in each transducer subassembly, almost no stray fields are produced or reproduced. In addition to very low noise reproduction, the containment of the flux in the manner to be described has several advantages. First, this very efficient design requires much fewer windings than traditional pickups to generate a usable signal, meaning manufacturing costs will be lower from both material and labor savings. Second, since very little magnetic field (and thus energy) is wasted in the space around the pickup, a much weaker permanent magnet or electromagnet driving current is needed for this pickup when compared to conventional designs. This has the potential to lower manufacturing costs and increase battery life in a powered design. Third, since the string vibrates in a gap in the pickup where the walls of the pickup core run parallel to the string, only the vibrations of the string perpendicular to the surface of the cut in the pickup core are reproduced. This is a desirable characteristic for pickups because it results in a clearer sound when compared to traditional pickups that respond to vibration in more than one plane. Reproducing vibrations in one spatial plane is also advantageous because its simple harmonic content is easier to convert into a digital signal than a traditional pickup. In addition, since the proposed configuration uses a single, simple transducer subassembly for each string rather than one large complicated pickup for the entire instrument, it scales in direct proportion to the number of strings on the instrument; thus, a pickup system for a harpsichord would be just as easy to make as a pickup system for a guitar, differing only in the number of small, inexpensive transducers needed. Finally, using a single transducer for each string has another important advantage: the frequency response of each transducer can be tailored specifically to the harmonic content of the string it is to reproduce, ensuring the best possible musical tone.

Although the pickup described herein would ideally operate with an individual electrical signal path for each string, this might not be possible within the context of the single input of standard guitar amplifiers. In order to interface with existing equipment, the transducers for multiple strings could be electrically combined in series or in parallel in order to function as a single pickup. While the previously described advantages of separating out the strings would be lost in this configuration, a pickup operating in such a fashion would be backwards compatible with old equipment, a very desirable trait. The pickup would still retain its low noise and high efficiency even in this configuration.

Additional objects and advantages will become apparent from a consideration of the drawings and ensuing descriptions.

### DESCRIPTION OF DRAWINGS

FIG. 1 is a perspective view of the basic invention.

FIG. 2 is a side view of the basic invention.

FIG. 3 is a front view of the basic invention.

FIG. 4 is a front view of an alternative embodiment of the invention for use with more than one string.

FIG. 5 is a perspective view of an alternative embodiment of the invention employing an electromagnet instead of a permanent magnet.

### REFERENCE NUMBERS IN DRAWINGS

1 magnetically susceptible transducer core
2 electrically conductive coil disposed on core 1
3 gap in core 1
3′ gap in core 1
4 magnetically susceptible string
4′ magnetically susceptible string
5 permanent magnet
5′ permanent magnet
6 magnetically susceptible magnetizing core
7 electrically conductive coil disposed on 6

### SUMMARY

The invention is a novel electromagnetic transducer employing specially shaped magnetically susceptible cores and/or permanent magnets in order to contain and guide magnetic flux.

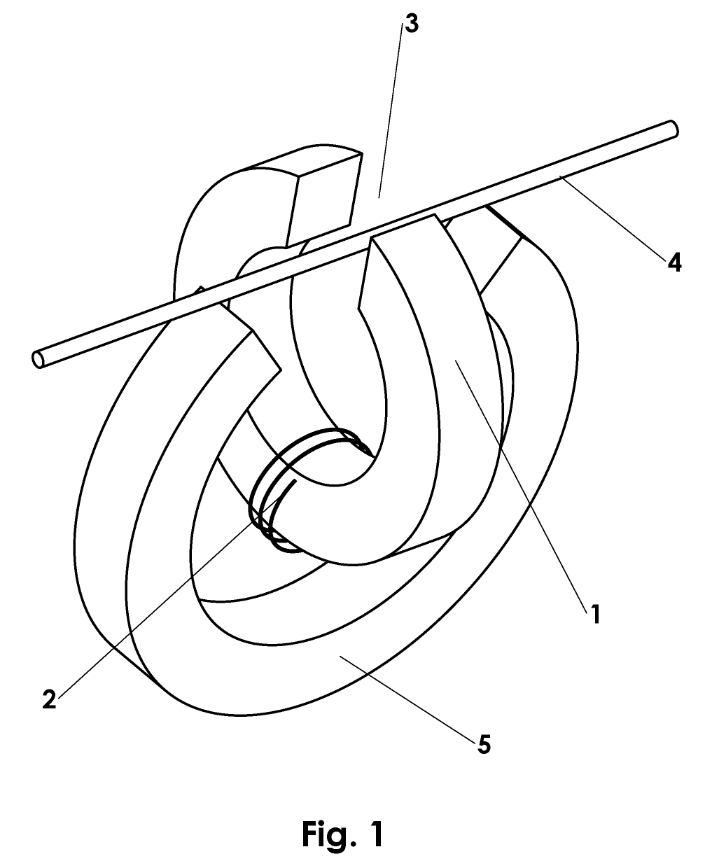

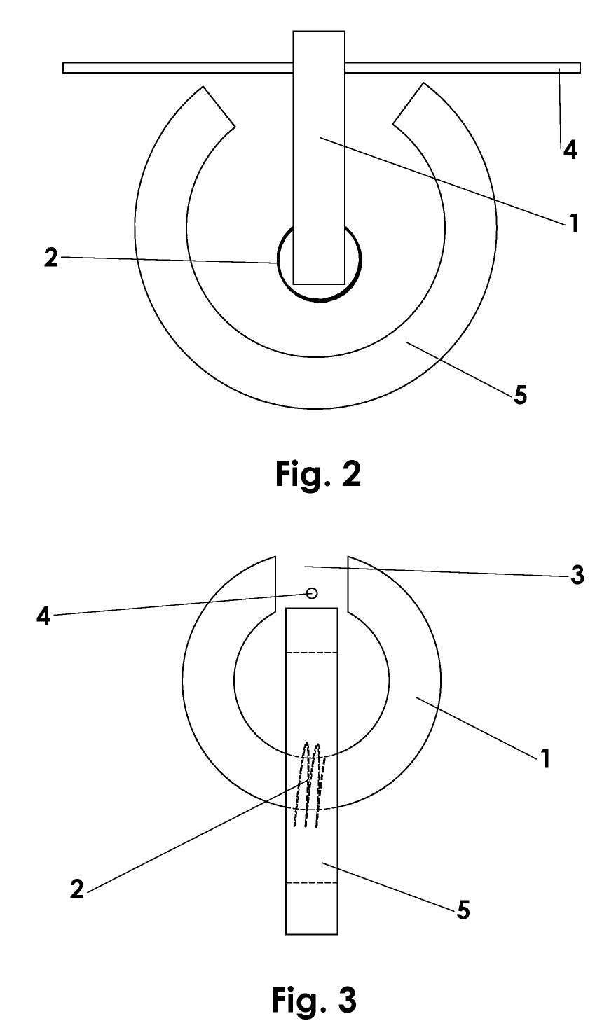

### DESCRIPTION OF INVENTION FIGS. 1 TO 5

A basic embodiment of the electromagnetic transducer of the invention is shown in FIG. 1-3. Fundamentally, the transducer consists of a magnetically susceptible transducer core 1 upon which one or more turns of an electrically conductive coil 2 are wound. Core 1 is shaped such that it provides a closed path for magnetic flux everywhere except a gap 3 in which a magnetically susceptible string 4 is present. In its preferred embodiment, core 1 would be essentially ring-shaped with gap 3 for the string. In order to drive magnetic flux lengthwise through string 4, it is necessary to provide a permanent magnet 5. This magnet is also shaped in such a way that it provides a closed path for magnetic flux everywhere except the area in which the flux is driven into string 4. Again, the preferred embodiment of this magnet would be ring shaped with a section cut out so the magnetic flux is driven into string 4.

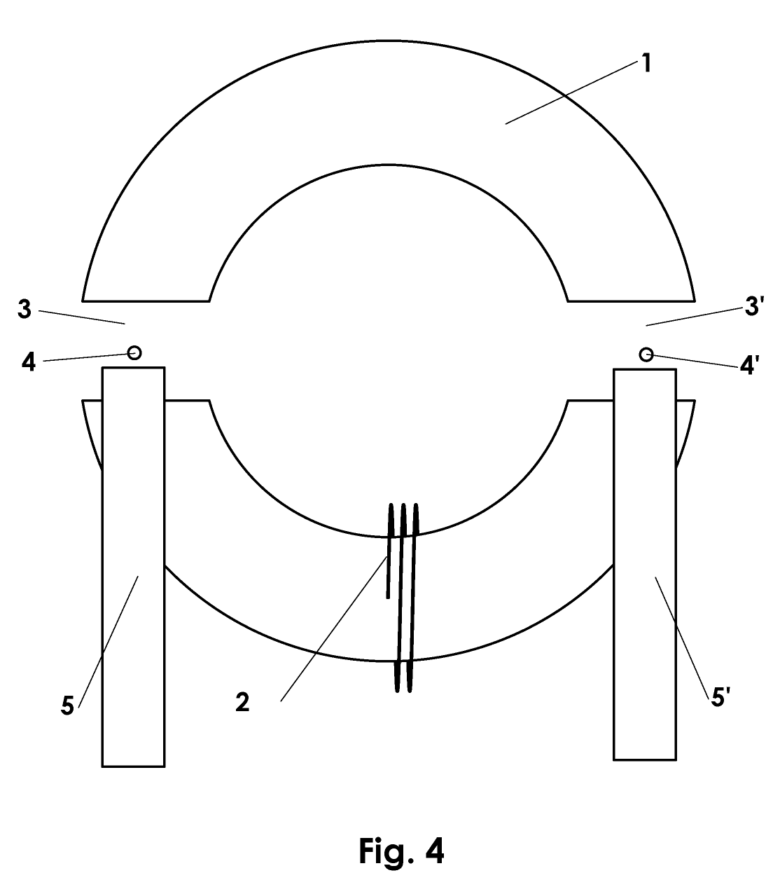

FIG. 4 shows an alternative embodiment in which a single such electromagnetic transducer is used for a plurality of strings 4 and 4′ by placing a plurality of gaps 3 and 3′ in core 1. In this configuration, it would be necessary to provide each string with a means of driving magnetic flux lengthwise, such as permanent magnets 5 and 5′. It would also be possible to put more than one string in a single gap for double-strung instruments, such as mandolins. In this configuration a plurality of strings tuned to a single pitch could share a means of driving magnetic flux since the strings of each course on double-strung instruments are very close together.

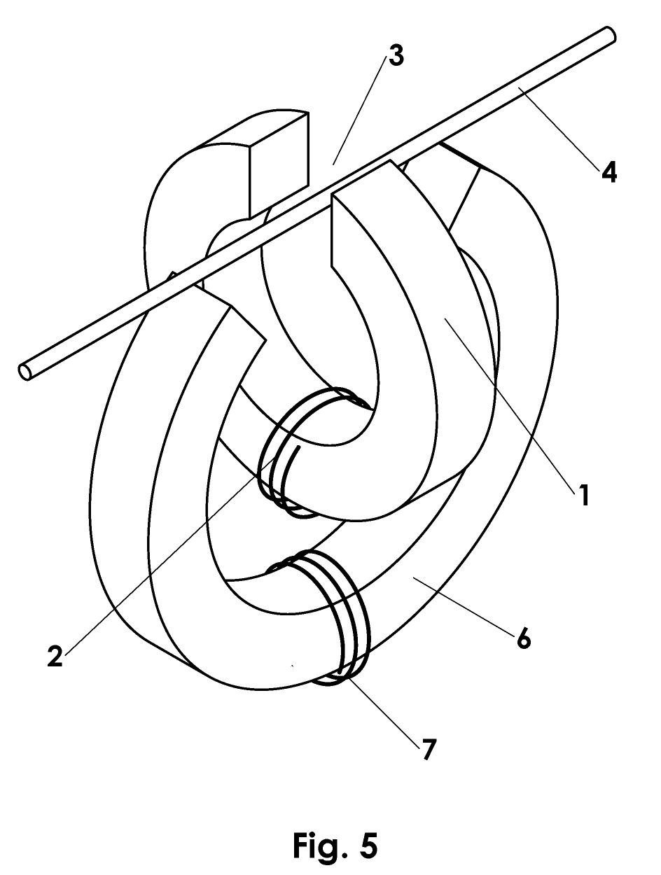

FIG. 5 shows an alternative embodiment that uses no permanent magnets. Instead of permanent magnet 5, one could employ a magnetically susceptible core 6, about which one or more turns of an electrically conductive coil 7 are wound to drive longitudinal magnetic flux in the string. Again, in its preferred embodying, this core is ring shaped with a section cut out so magnetic flux is driven on magnetically susceptible string 4.

Although not shown in the drawings for clarity of mechanical detail, the electromagnetic transducer elements should be encased in some sort of protective coating, such as a plastic. This casing is essential in order to protect the assembly from eventual corrosion due to contact with human hands. Naturally, a support structure and means of adjusting the spatial location of the individual components of the transducer subassembly would be provided in any commercial embodiment.

### Operation FIG. 1

When string 4 vibrates mechanically, the longitudinal magnetic field that is driven through the string by magnet 5 also vibrates. This vibration of the magnetic field drives magnetic flux through core 1 via gap 3. The magnetic flux driven through core 1 induces a current to flow in coil 2 on the core. The current flowing in coil 2 will be of the same harmonic content as the vibration of the string. This current can be amplified and reproduced electronically.

### CONCLUSIONS, RAMIFICATIONS, AND SCOPE OF INVENTION

Thus, it can be seen that the nearly closed magnetic flux electromagnetic transducer of the invention is a simple, economical, and efficient device to convert the mechanical vibration of a magnetically susceptible string into an electric signal. Additionally, the method of operation of this transducer provides a significant advantage of prior art by providing a transducer that, due to its efficiency, reproduces very little noise and is simple to manufacture. The transducer of this invention also makes reproducing the sound of each individual string in a single plane simple and allows the designer to tailor the frequency response of each transducer to the individual string that it is designed to reproduce. This transducer will also interface easily with digital systems for the reasons previously laid out. This transducer makes the electrification of instruments that use many strings simple since a pickup made of these transducer subassemblies scales in direct proportion to the number of strings. The transducer of this invention can also be configured into a pickup system that is backward compatible with traditional amplification and recording equipment because the signals of each individual transducer can be easily combined or aggregated into the single electric feed found on most existing electrified musical equipment.

Although this description of the invention is quite specific, this should not be construed as limiting the scope of the invention, but rather as providing an example of one preferred embodiment thereof. Many variations of the invention are possible. For example, it might prove more economical to use a magnetically susceptible core that is not perfectly rounded due to manufacturing difficulties or difficulty in mounting to the instrument. A variety of anti-corrosive coatings might be applied to the various parts of the transducer in order to increase its lifetime and comfort of use. Various means can be used to configure individual transducers into a pickup system for an instrument. Aggregation or combining of the signals from individual transducers can likewise be accomplished with a variety of means. Each element of the pickup might be provided with a means of adjusting its position relative to the other pickup elements in order to optimize efficiency and musical tone.

Accordingly, the scope of the invention should not be determined by the embodiments illustrated but rather by the appended claims and their legal equivalents.

I claim:

1. A nearly closed magnetic flux electromagnetic transducer subassembly comprising:
(a) a core of magnetically susceptible material shaped in such a way that magnetic flux is substantially contained in said core except at one or more gaps through which one or more magnetically susceptible strings pass
(b) one or more electrically conductive coils disposed on said core
(c) a means of driving magnetic flux lengthwise on said magnetically susceptible string or strings
(d) a support structure to maintain the spatial relations of elements a-c to one another and said magnetically susceptible string or strings
whereby the mechanical vibration of said magnetically susceptible string or strings may be reproduced electrically.

2. The nearly closed magnetic flux electromagnetic transducer subassembly of claim 1 wherein the means of driving magnetic flux lengthwise on said magnetically susceptible string or strings comprises a permanent magnet shaped in such a way as to substantially contain the magnetic flux of the system everywhere within said permanent magnet except a section wherein magnetic flux passes through said magnetically susceptible string in an approximately lengthwise direction.

3. The magnetic flux driving means of claim 2, further including a means of adjusting the spatial position of said permanent magnet.

4. The nearly closed magnetic flux electromagnetic transducer subassembly of claim 1 wherein the means of driving magnetic flux lengthwise on said magnetically susceptible string or strings comprises:
(a) a core of magnetically susceptible material shaped in such a way that the magnetic flux is essentially contained in said core except a section wherein magnetic flux passes through said magnetically susceptible string in an approximately lengthwise direction
(b) one or more electrically conductive coils disposed on said core
(c) a means of driving electrical current through said coil or coils
whereby magnetic flux is generated and focused in a lengthwise direction in said magnetically susceptible string or strings.

5. The mean of driving magnetic flux of claim 4, further including a means of adjusting the spatial position of the magnetically susceptible core.

6. The nearly closed magnetic flux electromagnetic transducer subassembly of claim 1, further including an anti-corrosion coating on the transducer elements.

7. The nearly closed magnetic flux electromagnetic transducer subassembly of claim 1, further including a means of adjusting the spatial position of the transducer elements.

8. An electromagnetic pickup system for a stringed musical instrument comprising any electrical combination of a plurality of nearly closed magnetic flux electromagnetic transducer subassemblies, wherein each said nearly closed magnetic flux electromagnetic transducer subassembly is comprised of:
(a) a core of magnetically susceptible material shaped in such a way that magnetic flux is substantially contained in said core except at one or more gaps through which one or more magnetically susceptible strings pass
(b) one or more electrically conductive coils disposed on said core
(c) a means of driving magnetic flux lengthwise on said magnetically susceptible string or strings
(d) a support structure to maintain the spatial relations of elements a-c to one another and said magnetically susceptible string or strings

9. The electromagnetic pickup system of claim 8 wherein said means of driving magnetic flux lengthwise on said magnetically permeable string is shared by two or more transducer subassemblies.

10. The electromagnetic pickup system of claim 8, further including a means of adjusting the spatial position of each element of each transducer subassembly.

11. The electromagnetic pickup system of claim 8, further including a means of adjusting the spatial position of each transducer subassembly.
